(19) United States
(12) Patent Application Publication
(10) Pub. No.: US 2004/0166475 A1
(43) Pub. Date: Aug. 26, 2004

(54) Sterilizable dental and surgical instrument

(76) Inventor: George Nikolov, Melbourne (AU)

Correspondence Address: Michael J. Foycik, Jr., #255, 1718 M St. N.W., Washington, DC, 20036, US

(21) Appl. No.: 10/370,769

(22) Filed: Feb. 24, 2003

(51) Int. Cl. A61C 3/14

(52) U.S. Cl. 433/159

(57) ABSTRACT

A sterilizable forceps is composed of two parts, a first component and a second component. The first component and the second component are preferably similar or even substantially identical to each other. The first component includes a handle portion, an intermediate portion, and a beak element. The intermediate portion has a generally flat upper surface, and has two opposed semicircular processes. The intermediate portion also has two groove portions. The first component has an upper shoulder portion, and carries a stop element on the handle portion. The first and second components can be separated simply by opening the handle portions to a maximum extended position. In the closed position, the semicircular processes of each component are engaged in groove portions formed by the other component.

### FIELD OF THE INVENTION

The present invention relates to a sterilizable dental and surgical instrument. More particularly, the present invention relates to a sterilizable dental and surgical instrument having only two, manually separable components and having no connecting pin or hinge.

### BACKGROUND OF THE INVENTION

Dental and surgical forceps and scissors are known in the prior art. Such prior art devices employ two opposing members connected by a hinge. Such hinges are typically made using a screw element or pin.

Examples of known devices include U.S. Pat. No. 3,454,009 to Hunnicutt, which discloses a simple clamp with a scissors-like shape. It shows arms connected together by interengaging elements formed integrally with the arms, those elements being disengaged at a position in which the jaws are widely separated. It has no pin or screw.

Another example is U.S. Pat. No. 2,632,661 to Cristofv, which shows a pinless joint using slots. It shows in FIG. 3 an element 26 can appears to be a pin or structure having a pin function.

U.S. Pat. No. 4,823,792 to Dulebohn et al. shows another type of pinless hinge, as in FIGS. 1 and 5 thereof.

U.S. Pat. No. 5,507,774 to Holmes et al. teaches a device which easily disassembles for sterilization. The device requires a pin 13 and recess 12 as shown in FIG. 9 thereof.

Other patents showing pin-type or screw-type hinges in dental and surgical instruments are also shown in U.S. Pat. No. 6,309,404 to Krzyzanowski, U.S. Pat. No. 6,132,441 to Grace, U.S. Pat. No. 5,722,989 to Fitch et al., U.S. Pat. No. 5,536,238 to Holmes et al., and U.S. Pat. No. 5,065,516 to Dulebohn.

It is, however, a problem in the art to provide an easily sterilizable forceps or similar dental or surgical instrument which can be readily sterilized after use, and which is of simple design and can be readily disassembled manually after use to enable cleaning and sterilization.

### SUMMARY OF THE INVENTION

From the foregoing, it is seen that it is a problem in the art to provide a device meeting the above requirements. According to the present invention, a device and process are provided which meets the aforementioned requirements and needs in the prior art. Specifically, the device according to the present invention provides a sterilizable dental and surgical instrument.

More particularly, the invention relates to a sterilizable dental and surgical instrument having only two, manually separable components and having no connecting pin or hinge. The hinged instrument, which may be embodied as a forceps, uses a mating joint between the two components instead of a screw or pin to form a hinged portion.

Furthermore, the present invention relates to a sterilizable dental and surgical instrument having only two, manually separable components and having no connecting pin or hinge, in which the two components are substantially identical.

Other objects and advantages of the present invention will be more readily apparent from the following detailed description when read in conjunction with the accompanying drawings.

### BRIEF DESCRIPTION OF THE DRAWINGS

FIG. 1 is a top elevational view of a sterilizable forceps according to the present invention, in an operational position clenching a tooth.

FIG. 2 is a top elevational view of a single element of the sterilizable forceps of FIG. 1.

FIG. 3 is a side elevational view of the single element of the sterilizable forceps as viewed from the right side in FIG. 2.

FIG. 4 is a top elevational view of the sterilizable forceps of FIG. 1, shown in an opened position in which manual separation of the components thereof is possible.

FIG. 5 is a bottom elevational view of the single element of the sterilizable forceps shown in FIG. 2, as viewed from the bottom of FIG. 2.

FIG. 6 is an end elevational view taken along line 6-6 of FIG. 1, showing an end view of the sterilizable forceps of FIG. 1.

FIG. 7 is a sectional view of a handle portion taken along line 7-7 of FIG. 3.

FIG. 8 is a sectional view of a beak portion taken along line 8-8 of FIG. 3.

FIG. 9 is a top elevational view of an alternative embodiment of the sterilizable forceps of FIG. 1, in which the component parts include light pipes and a lamp element.

FIG. 10 is a schematic view of a lamp and lamp circuit of the device shown in FIG. 9.

FIG. 11 is a top elevational view of another alternative embodiment of the sterilizable forceps of FIG. 1, in which the component parts include friction engagement elements.

### DETAILED DESCRIPTION OF THE INVENTION

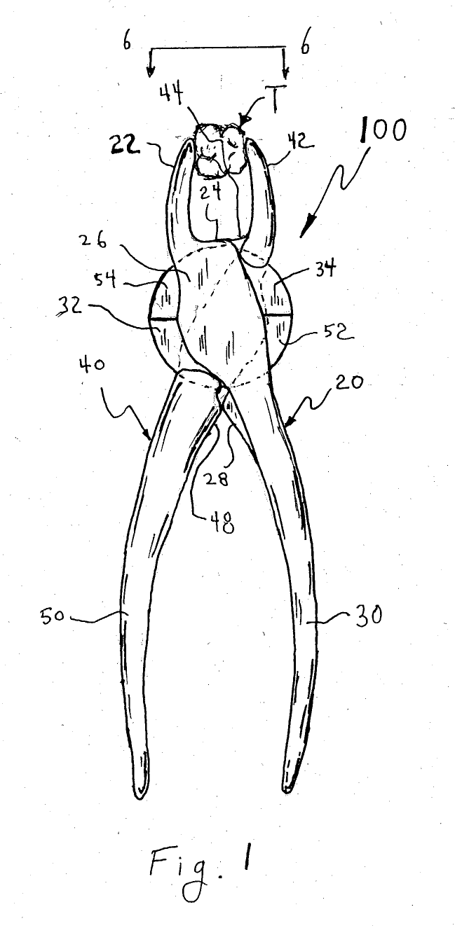

A sterilizable forceps 100 is shown in FIG. 1 in an operational position clenching a tooth T between two beak elements 22 and 42. The sterilizable forceps 100 is composed of two parts, a first component 20 and a second component 40. The first component 20 and the second component 40 are preferably similar or even substantially identical to each other.

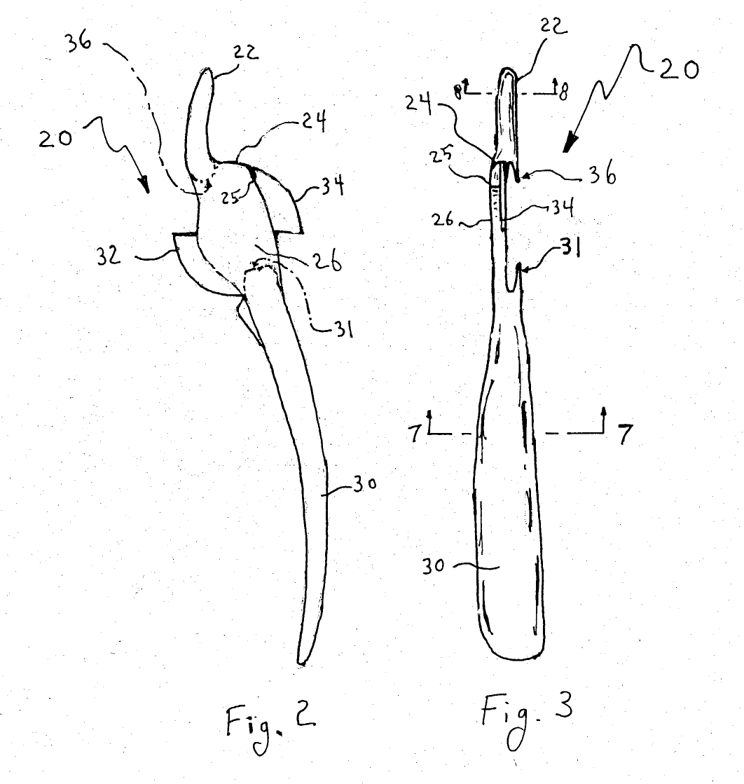

The first component 20 includes a handle portion 30, an intermediate portion 26, and a beak element 22. The intermediate portion 26 has a generally flat upper surface, and has two semicircular processes 32 and 34. As shown in FIGS. 2 and 3, the intermediate portion 26 also has two groove portions 31 and 36, as indicated generally by dashed outlines in FIG. 2 and shown in side view in FIG. 3. The first component has an upper shoulder portion 24, and carries a stop element 28 on the handle portion 30. The handle portion 50 likewise carries a stop element 48. The stop elements 28 and 48 can be omitted.

The second component 40 includes a handle portion 50, an intermediate portion 46, and a beak element 42. The intermediate portion 46 has a generally flat upper surface, and has two semicircular processes 52 and 54. The second component 40 is substantially identical to the first component 20, and therefore its reverse side to that shown in FIG. 1 can be considered as being shown in FIG. 2. Therefore, the following description of the first component 20 is applicable to the second component 40 as well. The intermediate portion 46 additionally has two groove portions similar to groove portions 31 and 36 described hereinabove.

The first component 20 and the second component 40 can be composed of steel or iron, for example, or of metal alloys such as brass or bronze. Additionally, the first component 20 and the second component 40 can furthermore be composed of plastic or carbon composite materials. If composed of plastic, the plastic can furthermore be fiber-reinforced, and can also be transparent.

Additionally, while the beak elements 22 and 42 of FIG. 1 are shown aligned generally with the handles 30 and 50, they can instead be formed so as to extend at an angle thereto. Also, the beak elements can be formed so as to be useful as clamping elements, or can be bladed so as to serves as cutting or shearing elements useful in surgery.

The materials used in the present invention may be any which would be within the ambit of one skilled in the dental or surgical arts. Also, the length, particular cross sections, angles used, curves along the length or width thereof, and variations in the surfaces thereof including coatings and coverings, can all be varied within the ambit of one skilled in the dental or surgical arts. All such modifications and changes are contemplated as being within the scope of the present invention.

FIG. 2 is a top elevational view of the first component 20 of the sterilizable forceps 100 of FIG. 1. In this view, the groove portions 31 and 36 are shown in dashed outline. The main body portion of the intermediate portion 26 is substantially planar and flat, so that when it is in an assembled configuration is faces and mates with the intermediate portion 46 of the second component 40.

The two semicircular processes 32 and 34 are substantially planar and flat on their upper and lower surfaces, and in an assembled position with the second component 40 the two semicircular processes 32 and 34 are engaged within grooves of the second component 40 which correspond to the groove portions 31 and 36 shown with respect to the first component 20 shown in FIGS. 2 and 3.

The handle portion 30 can be corrugated, grooved, ribbed, or smooth, or can carry indicia, coatings, or coverings. In a preferred embodiment, the handle portion 30 has crisscrossing grooves.

FIG. 3 is a side elevational view of the single element 20 of the sterilizable forceps 100 as viewed from the right side in FIG. 2. In this view, the groove portions 31 and 36 are shown in side view. The opposed flat surfaces of the semicircular process 34 are clearly seen in this view. The beak element 22 is inwardly concave, although other beak shapes are also contemplated as being within the scope of the present invention.

An angled transition region 25 is shown in FIGS. 2 and 3. This transition region can be made smooth and curved or arcuate, or can be composed of more than one faceted flat surface. The upper shoulder portion 24 is opposite to the groove 36.

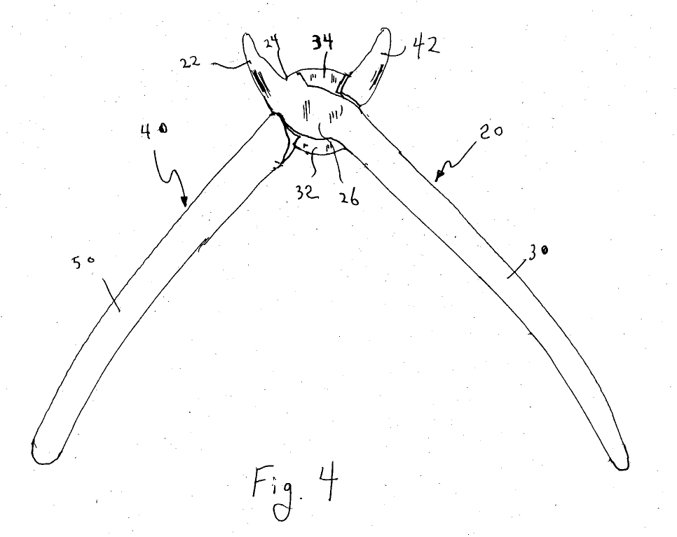

FIG. 4 is a top elevational view of the sterilizable forceps 100 of FIG. 1, shown in an opened position in which manual separation of the components thereof is possible. In this view, the forceps 100 is opened far wider than when it is in actual usage, and the parts are separable because the semicircular processes 32 and 34 are no longer engaged within the corresponding groove portions of the second component 40. As discussed hereinabove, those corresponding groove portions of the second component 40 are substantially identical to the groove portions 31 and 36 of the first component 20 which are as shown in FIG. 3.

Thus, in FIG. 4, the first component 20 can be removed simply by lifting it upwards in a direction transverse to the plane of the figure. However, in normal operation of the forceps 100, the handle portions 30 and 50 are much closer together and the entire forceps 100 functions much like any other type of manually operable hinged instrument or device.

FIG. 5 is a bottom elevational view of the single element 20 of the sterilizable forceps 100 shown in FIG. 2, as viewed from the bottom of FIG. 2. This view shows the planar surface 39 of the intermediate portion 26, as well as the shoulders forming the groove portions 31 and 36.

FIG. 6 is an end elevational view taken along line 6-6 of FIG. 1, showing an end view of the sterilizable forceps 100 of FIG. 1 in a closed position. In this view, the generally flat shapes of opposite surfaces of the intermediate portions 26 and 46 are seen. Also, uppermost shoulder portions 24 and 44 are shown of the intermediate portions 26 and 46, seen in end elevational view. The interrelationship of the semicircular processes 32 and 34 and the semicircular processes 52 and 54 are also shown in this view, wherein the respective semicircular processes project outwardly. Adjacent ones of the semicircular processes are offset slightly from the horizontal centerline of this figure, so as to be side-by-side.

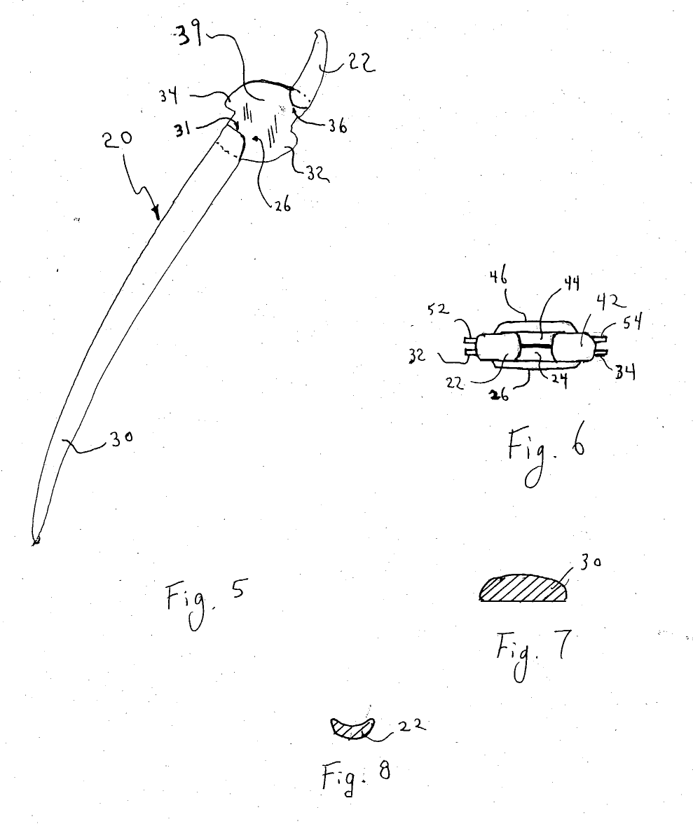

FIG. 7 is a sectional view of the handle portion 30 taken along line 7-7 of FIG. 3. Other cross sectional configurations are also contemplated as being within the scope of the present invention.

FIG. 8 is a sectional view of the beak portion 22 taken along line 8-8 of FIG. 3. Other cross sectional configurations are also contemplated as being within the scope of the present invention.

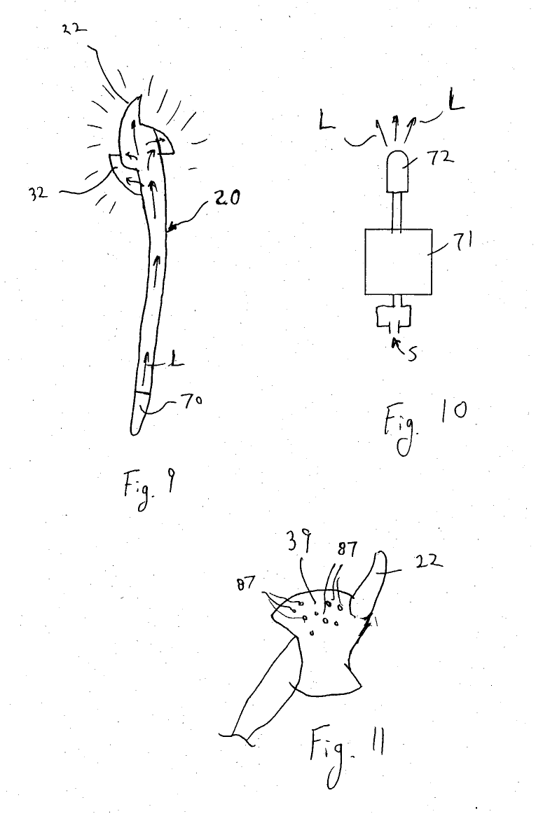

FIG. 9 is a top elevational view of an alternative embodiment of the sterilizable forceps of FIG. 1, in which the component parts include light pipes and a lamp element 70. The lamp element 70 is arranged so that light from a lamp is directed into the end of the handle portion of the component 20. The entire component 20 in this embodiment is preferably composed of a transparent material such as clear plastic. Thus, the component 20 serves as a light pipe, directing light from the lamp element 70 into the area to be operated upon, such as the interior of a patient's mouth.

FIG. 10 is a schematic view of the lamp element 70, which includes a lamp 72, and lamp circuit 71, of the device shown in FIG. 9. The lamp circuit 71 preferably contains a battery, and has a switch S which can be operated by pressure, or by sliding, or by touch by sensing capacitance. Such switches are well known, as are lamp elements and batteries suitable for such a use, including incandescent lamps or alternatively LED's. All such variations are contemplated as being within the scope of the present invention.

FIG. 11 is a top elevational view of another alternative embodiment of the sterilizable forceps of FIG. 1, in which the component parts include friction engagement elements 80. The friction engagement elements 80 can be slightly raise portions so that the forceps 100 will be frictionally retained in whatever position it is placed in, yet be manually movable. The amount of frictional resistance can be varied by varying the height of the friction engagement elements 80.

The invention being thus described, it will be evident that the same may be varied in many ways. Such variations are not to be regarded as a departure from the spirit and scope of the invention and all such modifications are intended to be included within the scope of the claims.

What is claimed is:

1. A sterilizable dental or surgical instrument having a working position and a separation position, comprising:
a first component having a handle, a beak, and an intermediate portion connecting said handle and said beak; said intermediate portion of said first component having two opposed semicircular processes, and having two generally opposed groove portions disposed about a periphery of the intermediate portion of the first component;
a second component having a handle, a beak, and an intermediate portion connecting said handle and said beak; said intermediate portion of said second component having two opposed semicircular processes, and having two generally opposed groove portions disposed about a periphery of the intermediate portion of the second component;
wherein in said working position, said two opposed semicircular processes of said first component are engaged within respective ones of said two generally opposed groove portions of said second component; and
wherein in said separation position, said two opposed semicircular processes of said first component are not engaged within respective ones of said two generally opposed groove portions of said second component;
whereby in said separation position, said first component can be manually removed from said second component.

2. A sterilizable dental or surgical instrument as claimed in claim 1, wherein said beak of said first component and said beak of said second component extend generally in parallel with a centerline between said handle portions.

3. A sterilizable dental or surgical instrument as claimed in claim 1, wherein said beak of said first component and said beak of said second component extend generally transversely to a centerline between said handle portions.

4. A sterilizable dental or surgical instrument as claimed in claim 1, wherein said first component and said second component are composed of steel.

5. A sterilizable dental or surgical instrument as claimed in claim 1, wherein said first component and said second component are composed of plastic.

6. A sterilizable dental or surgical instrument as claimed in claim 1, wherein said first component and said second component are composed of transparent material and serve as light pipes.

7. A sterilizable dental or surgical instrument as claimed in claim 1, further comprising a lamp element attached to a free end of a handle portion of said first component, connected so as to direct light through the handle portion and into said intermediate portion and said beak portion.

8. A sterilizable dental or surgical instrument as claimed in claim 1, further comprising at least one friction engagement element disposed on a surface of each respective one of said intermediate portions of said first and second components, such that in a working position the first and second components will be retained in their relative positions by frictional forces therebetween, while being manually movable into other positions by a force sufficient to overcome the frictional force therebetween.
